(19) United States
(12) Patent Application Publication
(10) Pub. No.: US 2025/0108399 A1
(43) Pub. Date: Apr. 3, 2025

(54) RINSING NOZZLE

(71) Applicant: DISCO CORPORATION, Tokyo (JP)

(72) Inventor: Kohei YANAGIYA, Tokyo (JP)

(21) Appl. No.: 18/886,963

(22) Filed: Sep. 16, 2024

(30) Foreign Application Priority Data
Sep. 28, 2023 (JP) 2023-166684

(51) Int. Cl. B05B 17/06

(52) U.S. Cl. CPC B05B 17/0669; B05B 17/0615

(57) ABSTRACT

There is provided a rinsing nozzle for rinsing an object by supplying liquid to the object while propagating ultrasonic waves to the liquid. The rinsing nozzle includes a case, a flat vibration plate, and a plurality of transducers. The case has an internal space that holds the liquid therein, a supply port that supplies the liquid from the internal space toward the object, and a connecting portion that connects a liquid supply source, which supplies the liquid, and the internal space. The vibration plate is disposed in the internal space in such a manner as to face the supply port. The transducers apply ultrasonic waves to the vibration plate. Propagation of ultrasonic waves to be applied from the vibration plate to the liquid can be controlled by phased array control of the transducers.

### BACKGROUND OF THE INVENTION

### Field of the Invention

The present invention relates to a rinsing nozzle for rinsing an object by supplying liquid to the object.

### Description of the Related Art

Device chips with devices included therein are manufactured by division of a wafer, on which the devices are formed, into individual chips. Further, a package substrate is formed by such device chips being mounted on a predetermined substrate and the mounted device chips being covered and sealed with a resin layer (mold resin). By such a package substrate being divided and singulated, package devices are each manufactured including a plurality of the packaged devices. Device chips and package devices are incorporated in various kinds of electronic equipment such as mobile phones and personal computers.

When being divided into chips, a workpiece such as a wafer or a package substrate is processed by various types of processing apparatuses. To divide the workpiece, use can be made, for example, of a cutting apparatus that cuts the workpiece by an annular cutting blade, a laser processing apparatus that applies laser processing to the workpiece, or the like. Further, thin chips are obtained by the workpiece being ground and thinned with a grinding apparatus before being divided.

When the workpiece is processed by such a processing apparatus as described above, debris (processing debris) that is generated by the processing scatters around, and deposits on the workpiece. After the processing of the workpiece, a rinsing step is hence performed to rinse the workpiece with use of a rinsing apparatus. The rinsing apparatus supplies liquid for rinsing (rinsing liquid) to the workpiece, thereby washing away processing debris stuck on the workpiece, and hence rinsing the workpiece.

If the processing debris is firmly deposited on the workpiece, mere supply of the rinsing liquid to the workpiece cannot fully remove the processing debris, resulting in insufficient rinsing of the workpiece. A rinsing apparatus including a rinsing nozzle that applies ultrasonic vibrations to the rinsing liquid has hence been proposed (see Japanese Patent Laid-open No. 2022-28313). The rinsing nozzle includes, for example, a vibration plate formed in a dome-type, recessed spherical shape, and the vibration plate is vibrated to apply ultrasonic vibrations to the rinsing liquid. By the rinsing liquid to which the ultrasonic vibrations have been applied being supplied to the workpiece, separation of the processing debris from the workpiece is facilitated, so that the workpiece is effectively rinsed.

### SUMMARY OF THE INVENTION

If a vibration plate that applies ultrasonic vibrations to liquid for rinsing in a rinsing nozzle is formed in a dome-type, recessed spherical shape as described above, ultrasonic waves can be converged in a vicinity of a supply port of the rinsing nozzle and can be facilitated to reach an object to be processed while being allowed to retain high intensity. The use of a vibration plate of a recessed spherical shape has however been confirmed to facilitate accumulation of air in a vicinity of a recessed sphere of the vibration plate. If air accumulates in the vicinity of the recessed sphere of the vibration plate, an air layer is formed between the vibration plate and the liquid, inhibiting propagation of the ultrasonic waves from the vibration plate to the liquid. As a result, the ultrasonic waves are made less likely to appropriately propagate to the object, leading to a problem that the rinsing efficiency of the object may be lowered.

With the foregoing problem in view, the present invention has as an object thereof the provision of a rinsing nozzle that allows efficient propagation of ultrasonic waves to an object via liquid for rinsing.

In accordance with an aspect of the present invention, there is provided a rinsing nozzle for rinsing an object by supplying liquid to the object while propagating ultrasonic waves to the liquid, including a case having an internal space that holds the liquid therein, a supply port that supplies the liquid from the internal space toward the object, and a connecting portion that connects a liquid supply source, which supplies the liquid, and the internal space, a flat vibration plate disposed in the internal space in such a manner as to face the supply port, and a plurality of transducers that apply ultrasonic waves to the vibration plate. Propagation of ultrasonic waves to be applied from the vibration plate to the liquid can be controlled by phased array control of the transducers.

Preferably, the rinsing nozzle may be configured to allow the ultrasonic waves applied from the vibration plate to the liquid to converge on a straight line that is perpendicular to the supply port and that passes through a center of the supply port. Also preferably, the transducers may be arrayed in a grid pattern. Also preferably, the transducers may be formed in a circular or annular shape and may be arranged concentrically.

The rinsing nozzle according to the aspect of the present invention is so configured that the propagation of the ultrasonic waves to be applied from the vibration plate to the liquid for rinsing can be controlled by the phased array control of the transducers. As a consequence, the ultrasonic waves can be efficiently propagated to the object via the liquid.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically depicting a rinsing apparatus;

FIG. 2 is a partly cross-sectional front view schematically depicting the rinsing apparatus;

FIG. 3 is a cross-sectional view depicting a rinsing nozzle according to an embodiment of the present invention;

FIG. 4 is a schematic diagram depicting how ultrasonic waves propagate in liquid;

FIG. 5A is a contour figure presenting a sound pressure of ultrasonic waves created by phased array control with a phase shift set at 0°;

FIG. 5B is a contour figure presenting the sound pressure of ultrasonic waves created by phased array control with a phase shift set at 45°;

FIG. 5C is a contour figure presenting the sound pressure of ultrasonic waves created by phased array control with a phase shift set at 90°;

FIG. 5D is a contour figure presenting the sound pressure of ultrasonic waves created by phased array control with a phase shift set at 135°;

FIG. 6A is a plan view depicting a first specific example of a vibration applying unit;

FIG. 6B is a plan view depicting a second specific example of the vibration applying unit; and

FIG. 6C is a plan view depicting a third specific example of the vibration applying unit.

### DETAILED DESCRIPTION OF THE PREFERRED EMBODIMENT

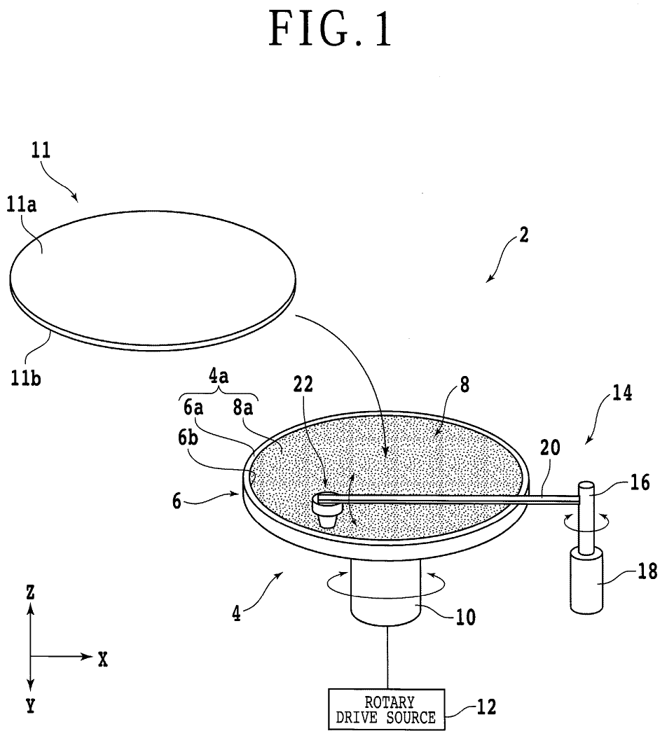

With reference to the attached drawings, a description will hereinafter be made of an embodiment according to the aspect of the present invention. A description will first be made of the configuration example of a rinsing apparatus on which a rinsing nozzle according to this embodiment can be mounted. FIG. 1 is a perspective view schematically depicting a rinsing apparatus 2 that rinses an object 11. It is to be noted that, in FIG. 1, an X-axis direction (left-to-right direction, first horizontal direction) and a Y-axis direction (front-to-rear direction, second horizontal direction) are directions perpendicular to each other. It is also to be noted that a Z-axis direction (up-to-down direction, height direction, vertical direction) is a direction perpendicular to the X-axis direction and the Y-axis direction.

The object 11 is equivalent to an item to be rinsed which is an object to be rinsed by the rinsing apparatus 2. Described specifically, the object 11 is a workpiece to which such processing as cutting processing, grinding processing, polishing processing, and/or laser processing is applied. After predetermined processing is applied to the object 11, the object 11 is rinsed by the rinsing apparatus 2.

For example, the object 11 is a disk-shaped wafer made from a semiconductor material such as single-crystal silicon, and includes a first surface 11a and a second surface 11b substantially parallel to each other. The object 11 is defined into a plurality of rectangular regions by a plurality of streets (scribe lines) that are arrayed in a grid pattern in such a manner as to intersect. In the regions defined by the streets, devices (not depicted) such as integrated circuit (IC), large scale integration (LSI), light emitting diode (LED), or micro electro mechanical system (MEMS) devices are formed. By the object 11 being divided along the streets through cutting processing, laser processing, or the like, a plurality of device chips of a similar kind are manufactured including the devices, respectively. Thinned device chips are also obtained if the object 11 is thinned through grinding processing and/or polishing processing before being divided.

No limitations are however imposed on the kind, material, size, shape, construction, and the like of the object 11. For example, the object 11 may be a wafer (substrate) made from a semiconductor (GaAs, InP, GaN, SiC, or the like) other than silicon, sapphire, glass, ceramic, resin, metal, or the like. No limitations are imposed either on the kind, number, shape, structure, size, arrangement, and the like of the devices. No devices may be formed on the object 11. Further, the object 11 may also be a package substrate such as a chip size package (CSP) substrate or a quad flat non-leaded package (QFN) substrate. The package substrate may be formed, for example, by a plurality of device chips being mounted on a predetermined substrate and the mounted device chips being covered and sealed with a resin layer (mold resin). By the package substrate being divided and singulated, package devices are manufactured including a plurality of packaged device chips of a similar kind.

For the processing of the object 11, various types of processing apparatuses are used. Examples of such processing apparatuses include a cutting apparatus that cuts the object 11, a grinding apparatus that grinds the object 11, a polishing apparatus that polishes the object 11, a laser processing apparatus that applies laser processing to the object 11, and the like.

The cutting apparatus includes a processing unit (cutting unit) that cuts the object 11. The cutting unit includes a spindle, and an annular cutting blade is fitted on a distal end portion of the spindle. By the cutting blade being caused to cut into the object 11 while kept rotating, the object 11 is cut.

The grinding apparatus includes a processing unit (grinding unit) that grinds the object 11. The grinding unit includes a spindle, and an annular grinding wheel with a plurality of grinding stones included therein is secured to a distal end portion of the spindle. By the grinding stones being brought into contact with the object 11 while kept rotating, the object 11 is ground.

The polishing apparatus includes a processing unit (polishing unit) that polishes the object 11. The polishing unit includes a spindle, and a disk-shaped polishing pad is secured to a distal end portion of the spindle. By the polishing pad being brought into contact with the object 11 while kept rotating, the object 11 is polished.

The laser processing apparatus includes a processing unit (laser irradiation unit) that irradiates the object 11 with a laser beam. For example, the laser irradiation unit includes a laser oscillator and a condenser that converges the laser beam emitted from the laser oscillator. By the laser beam which has been irradiated from the laser irradiation unit being converged on or in the first surface 11a or the second surface 11b of the object 11, laser processing is applied to the object 11.

When the object 11 is processed by such a processing apparatus as described above, debris (processing debris) that has been generated by the processing sticks on the object 11. After completion of the processing of the object 11, the object 11 is hence transferred to a rinsing apparatus 2, and is rinsed by the rinsing apparatus 2. As a consequence, such contaminants as processing debris stuck on the object 11 are washed away. It is to be noted that the rinsing apparatus 2 may be mounted on the processing apparatus, or may be installed independently of the processing apparatus.

The rinsing apparatus 2 includes a holding table (chuck table) 4 that holds the object 11 and a rinsing unit (rinsing mechanism) 14 that rinses the object 11. The holding table 4 has an upper surface, which is a planar surface substantially parallel to the horizontal plane (X-Y plane) and constitutes a holding surface 4a on which the object 11 is held. The object 11 held on the holding surface 4a of the holding table 4 is rinsed by the rinsing unit 14.

The holding table 4 includes a cylindrical frame body (main body portion) 6 made from metal such as stainless steel (SUS), glass, ceramic, or resin. In a central portion on a side of an upper surface 6a of the frame body 6, a cylindrical recessed portion (recess) 6b is provided. Further, a disk-shaped holding member 8 formed of a porous member of porous ceramic is fitted in the recessed portion 6b. The holding member 8 includes therein a number of pores (flow paths) that communicate from an upper surface to a lower surface of the holding member 8.

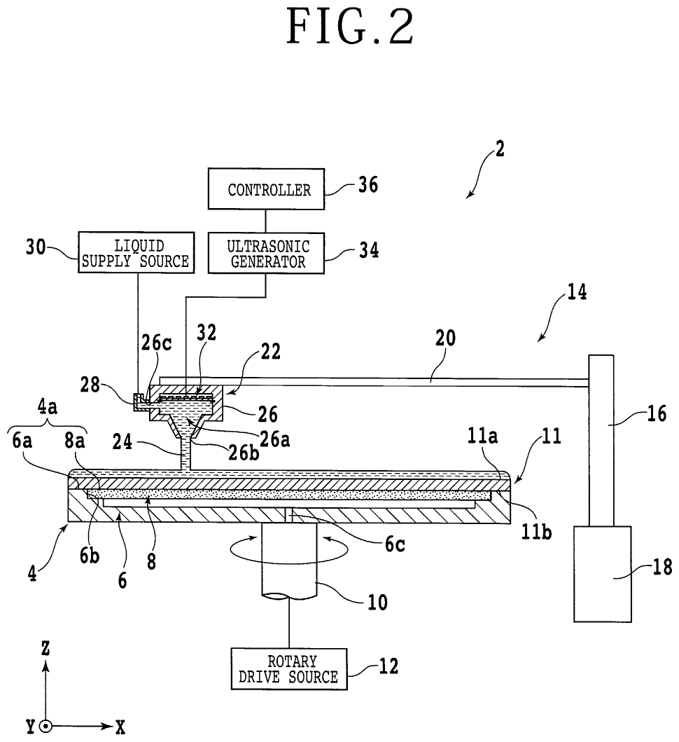

The upper surface of the holding member 8 constitutes a circular suction surface 8a that draws the object 11. The recessed portion 6b has a depth set substantially the same as a thickness of the holding member 8, so that the upper surface 6a of the frame body 6 and the suction surface 8a of the holding member 8 are arranged on substantially the same plane. The holding surface 4a of the holding table 4 is constituted by the upper surface 6a of the frame body 6 and the suction surface 8a of the holding member 8. The holding surface 4a is connected to a suction source (not depicted) such as an ejector via the pores included in the holding member 8, a flow channel 6c (see FIG. 2) formed through the frame body 6, a valve (not depicted), and the like.

The frame body 6 is supported by a cylindrical support shaft 10. The support shaft 10 is arranged along the Z-axis direction, and the frame body 6 is fixed at a central portion on a side of a lower surface thereof on an upper end portion of the support shaft 10. In addition, a rotary drive source 12 such as a motor that rotates the support shaft 10 is connected to a side of a lower end of the support shaft 10. When the rotary drive source 12 is operated, the holding table 4 and the support shaft 10 are rotated about an axis of rotation that is substantially parallel to the Z-axis direction.

The rinsing unit 14 is arranged sideward of the holding table 4. The rinsing unit 14 includes a cylindrical support shaft 16 arranged along the Z-axis direction. To a proximal end portion (lower end portion) of the support shaft 16, a rotary drive source 18 such as a motor is connected to rotate the support shaft 16 about an axis of rotation that is substantially parallel to the Z-axis direction. Meanwhile, to a distal end portion (upper end portion) of the support shaft 16, a cylindrical support arm 20 is connected. The support arm 20 is fixed on the support shaft 16 in such a manner as to extend substantially parallel to the X-Y plane. To a distal end portion of the support arm 20, a rinsing nozzle 22 according to this embodiment is secured. The rinsing nozzle 22 rinses the object 11 by supplying a liquid while propagating ultrasonic waves to the liquid.

When the rotary drive source 18 is operated and the support shaft 16 is rotated, the rinsing nozzle 22 is caused to swing, together with the support arm 20, along the X-Y plane, centering around the axis of rotation of the support shaft 16. This can position the rinsing nozzle 22 at a position (supply position) where the rinsing nozzle 22 overlaps with the holding surface 4a in the Z-axis direction or at a position (retracted position) where the rinsing nozzle 22 does not overlap with the holding surface 4a in the Z-axis direction. The rinsing nozzle 22 has a swing trajectory set, for example, to pass through an axis of rotation of the holding table 4.

FIG. 2 is a partly cross-sectional front view schematically depicting the rinsing apparatus 2. The rinsing nozzle 22 rinses the object 11 by supplying a liquid for rinsing (rinsing liquid) 24 to the object 11. As the liquid 24, pure water is used, for example. A description will hereinafter be made of configuration details of the rinsing nozzle 22.

The rinsing nozzle 22 includes a case (main body portion) 26 made from metal or the like. Inside the case 26, an internal space (holding portion) 26a is disposed to temporarily hold the liquid 24. For example, an upper portion of the internal space 26a is formed in a cylindrical shape, while a lower portion of the internal space 26a is formed in a shape of a tapered and truncated circular cone.

On a side of a lower surface of the case 26, a supply port 26b is disposed to supply the liquid 24 from the internal space 26a toward the object 11. The supply port 26b corresponds to a circular region exposed on the side of the lower surface of the case 26, and is connected to the internal space 26a. The liquid 24 held in the internal space 26a is allowed to flow out at a predetermined flow rate from the supply port 26b.

In a side wall of the case 26, there is disposed a flow channel 26c through which the liquid 24 to be supplied to the rinsing nozzle 22 flows. A side of one end of the flow channel 26c is exposed at a side surface of the rinsing nozzle 22, while a side of the other end of the flow channel 26c is connected to the internal space 26a. Yet, no limitation is imposed on the position where the flow channel 26c is to be disposed.

The rinsing nozzle 22 also includes a connecting portion 28 connected to a liquid supply source 30 that supplies the liquid 24. The connecting portion 28 is constituted by a conduit such as a pipe or a tube connected to the flow channel 26c of the rinsing nozzle 22, and connects the liquid supply source 30 and the internal space 26a together via the flow channel 26c. It is to be noted that the connecting portion 28 may be provided with a valve or the like that adjusts the flow rate of the liquid 24 to be supplied to the flow channel 26c.

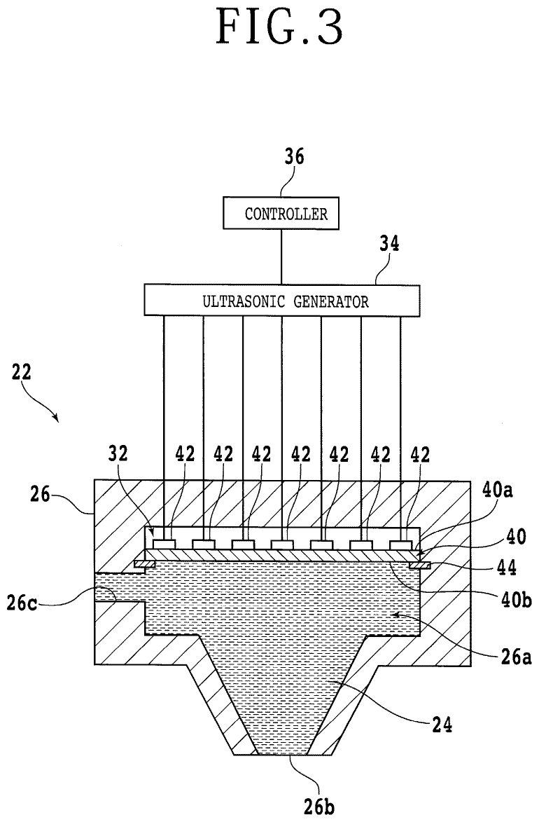

In the internal space 26a of the rinsing nozzle 22, a vibration applying unit (ultrasonic wave applying unit) 32 is disposed. The vibration applying unit 32 applies ultrasonic waves to the liquid 24 held in the internal space 26a, thereby applying ultrasonic vibrations (vibrations at a frequency belonging to the ultrasonic band) to the liquid 24. To the vibration applying unit 32, an ultrasonic generator 34 is connected to control the application of ultrasonic vibrations from the vibration applying unit 32 to the liquid 24. Configuration and function details of the vibration applying unit 32 and the ultrasonic generator 34 will be described later (see FIG. 3 onwards).

The rinsing apparatus 2 also includes a controller (control unit, control section, control system) 36 that controls the rinsing apparatus 2. The controller 36 is connected to individual elements (the holding table 4, the rotary drive source 12, the rotary drive source 18, the rinsing nozzle 22, the liquid supply source 30, the vibration applying unit 32, the ultrasonic generator 34, and so on) that constitute the rinsing apparatus 2. The controller 36 allows the rinsing apparatus 2 to operate, by outputting control signals to the individual elements of the rinsing apparatus 2.

The controller 36 is constituted, for example, by a computer. Described specifically, the controller 36 includes a processing section that executes processing such as computation processing required for the operation of the rinsing apparatus 2 and a storage section that stores various kinds of information (data, programs, etc.) to be used for the operation of the rinsing apparatus 2. The processing section is configured including a processor such as a central processing unit (CPU). The storage section is configured including a memory such as a read-only memory (ROM) and/or a random-access memory (RAM). It is to be noted that, if the rinsing apparatus 2 is mounted on a processing apparatus, a controller of the processing apparatus may also include the functions of the controller 36.

When the object 11 is to be rinsed by the rinsing apparatus 2, the object 11 is first held on the holding table 4. If the object 11 is rinsed on the side of the first surface 11a, for example, the object 11 is arranged on the holding table 4 such that the side of the first surface 11a (the surface to be rinsed) is exposed upward and the side of the second surface 11b faces the holding surface 4a. When a suction force (negative pressure) of the suction source is caused to act on the holding surface 4a in this state, the object 11 is held under suction on the holding table 4. When the second surface 11b of the object 11 is rinsed, the object 11 is held on the holding table 4 such that the second surface 11b is exposed upward.

Next, the rotary drive source 18 is operated to swing the rinsing nozzle 22, and the rinsing nozzle 22 is positioned to overlap with the object 11 in the Z-axis direction. With the holding table 4 kept rotating by the operation of the rotary drive source 12, the liquid 24 is supplied from the supply port 26b of the rinsing nozzle 22 toward the object 11. As a consequence, the liquid 24 is supplied to the side of the first surface 11a of the object 11. At this time, the liquid 24 may be supplied to the object 11 while the rinsing nozzle 22 reciprocally swung above the object 11.

The liquid 24 supplied to the object 11 radially spreads toward a side of an outer peripheral edge of the object 11 by a centrifugal force working on the rotating object 11. As a result, the liquid 24 flows along the first surface 11a of the object 11, so that such contaminants as processing debris stuck on the side of the first surface 11a of the object 11 are rinsed away. The rinsing of the object 11 by the rinsing apparatus 2 is performed in this manner.

It is to be noted that, when the liquid 24 is supplied from the rinsing nozzle 22 to the object 11, ultrasonic vibrations are applied to the liquid 24 by the vibration applying unit 32. With the liquid 24 used as a medium, the ultrasonic vibrations are then transmitted to the side of the first surface 11a of the object 11, thereby vibrating the contaminants stuck on the side of the first surface 11a. This facilitates removal of contaminants firmly deposited on the object 11. A description will hereinafter be made of details of the vibration applying unit 32.

FIG. 3 is a cross-sectional view depicting the rinsing nozzle 22 with the vibration applying unit 32 accommodated in the internal space 26a of the case 26. The vibration applying unit 32 includes a flat vibration plate 40 and a plurality of transducers 42 that apply ultrasonic vibrations to the vibration plate 40.

For example, the vibration plate 40 is a disk-shaped member made from metal such as SUS, and includes a planar first surface (upper surface) 40a and a planar second surface (lower surface) 40b substantially parallel to each other. The vibration plate 40 is arranged in a region of the internal space 26a, the region being located above the flow channel 26c, so as to face the supply port 26b.

An annular support member 44 is disposed on the case 26. The annular support member 44 is formed, for example, along a side wall of the internal space 26a. The support member 44 is arranged to project from the side wall of the internal space 26a toward a center of the internal space 26a, and has an inner diameter smaller than a diameter of the vibration plate 40. The vibration plate 40 is arranged on the support member 44 such that the first surface 40a is directed upward and the second surface 40b is directed downward. As a consequence, the vibration plate 40 is supported at an outer peripheral portion thereof by the support member 44. Further, the first surface 40a and the second surface 40b are arranged substantially parallel to the supply port 26b, and the second surface 40b faces the supply port 26b.

The transducers 42 are connected to a side of the first surface 40a of the vibration plate 40. Each transducer 42 is, for example, a piezoelectric element that vibrates by impression of a voltage. This piezoelectric element is formed including a piezoelectric ceramic such as lead zirconate titanate (PZT) and electrodes across which the voltage is impressed on the piezoelectric ceramic. The transducers 42 are arrayed such that their distances from a center of the vibration plate 40 differ.

The transducers 42 are all connected to the ultrasonic generator 34. The ultrasonic generator 34 generates ultrasonic waves, and supplies radiofrequency power to the transducers 42. As a consequence, the transducers 42 each vibrate at a frequency (20 kHz or higher) belonging to the ultrasonic band. It is to be noted that the radiofrequency power to be supplied from the ultrasonic generator 34 to the transducers 42 may be set through control of the ultrasonic generator 34 by the controller 36, or may be autonomously set by the ultrasonic generator 34.

When the liquid 24 is supplied from the liquid supply source 30 (see FIG. 2) to the internal space 26a via the connecting portion 28 (see FIG. 2) and the flow channel 26c and the internal space 26a is filled up with the liquid 24, the liquid 24 comes into contact with the vibration plate 40. When radiofrequency power is supplied from the ultrasonic generator 34 to the transducers 42 in this state, the transducers 42 vibrate at the frequency belonging to the ultrasonic band, and ultrasonic vibrations emitted from the transducers 42 all propagate to the vibration plate 40 and reach the liquid 24. As a result, ultrasonic waves are applied to the liquid 24 and are allowed to propagate in the liquid 24, so that ultrasonic vibrations are applied to the liquid 24.

In the rinsing nozzle 22 according to this embodiment, the flat vibration plate 40 is used, and the planar second surface 40b comes into contact with the liquid 24. Compared with the case in which a vibration plate formed in a dome-type, recessed spherical shape is used, air is less likely to remain between the vibration plate 40 and the liquid 24, thereby enabling avoidance of inhibition of transmission of ultrasonic vibrations from the vibration plate 40 to the liquid 24 by an air layer. In addition, the rinsing nozzle 22 according to this embodiment is configured to enable, by phased array control of the transducers 42, control of propagation of ultrasonic vibrations to be applied from the vibration plate 40 to the liquid 24. Despite the flat shape of the vibration plate 40, ultrasonic waves are efficiently allowed to reach the object 11 with the liquid being used as a medium, thereby facilitating the removal of contaminants stuck on the object 11.

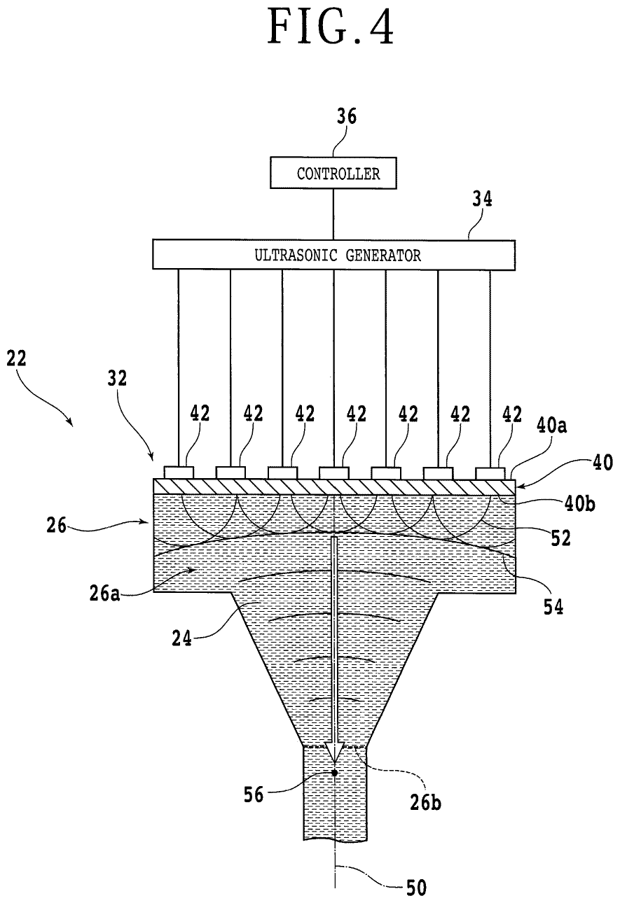

FIG. 4 is a schematic diagram depicting how ultrasonic waves propagate in the liquid 24. FIG. 4 schematically depicts the liquid 24 held in the internal space 26a of the case 26, the vibration plate 40, and the transducers 42. FIG. 4 also depicts a reference line 50 extending through the center of the internal space 26a. The reference line 50 is a hypothetical straight line which is perpendicular to the supply port 26b and passes through a center of the supply port 26b and the center of the vibration plate 40.

When radiofrequency power is supplied from the ultrasonic generator 34 to the transducers 42, the transducers 42 vibrate and apply ultrasonic vibrations to the vibration plate 40. The ultrasonic vibrations then propagate to the liquid 24 via the vibration plate 40, and a plurality of ultrasonic waves 52 are applied to the liquid 24 from the vibration plate 40.

Here, the ultrasonic generator 34 controls, through phased array control of the transducers 42, the propagation of ultrasonic waves in the liquid 24. The term “phased array control” means to adjust the propagating directions, the converging positions, and the like of ultrasonic waves by controlling the phases of ultrasonic vibrations, which are generated by the transducers 42, independently of one another. The ultrasonic generator 34 supplies radiofrequency power to the transducers 42, for example, such that ultrasonic vibrations to be emitted by each transducer 42 are more delayed in phase as the transducer 42 is located closer to the center of the vibration plate 40 (the reference line 50). The ultrasonic wave 52 created at a position closer to the center of the vibration plate 40 is thus more delayed in phase. The individual ultrasonic waves 52 generated by the respective transducers 42 are then combined together to create an ultrasonic wave (the resultant wave) 54, which converges while propagating in the liquid 24 toward the supply port 26b. These ultrasonic waves 54 propagate with the liquid 24 being used as a medium, whereby ultrasonic vibrations are applied to the liquid 24.

When the transducers 42 are controlled as described above, the ultrasonic waves 54 that propagate in the liquid 24 converge on the reference line 50. The ultrasonic waves 54 converge, for example, at a converging position (focal point) 56 located in the supply port 26b or its vicinity. As a consequence, the ultrasonic vibrations that have passed through the supply port 26b are facilitated to reach the object 11 (see FIG. 2) while retaining high intensity.

The converging position 56 of the ultrasonic waves 54 can appropriately be adjusted by control of the phase shifts of the ultrasonic vibrations emitted by the transducers 42. For example, as depicted in FIG. 4, the phase shifts of ultrasonic vibrations to be emitted by the transducers 42 may be set such that the ultrasonic waves 54 converge at the converging position 56 located on an outer side of the supply port 26b (on a side closer to the object 11 than the supply port 26b). This enables the ultrasonic waves 54 to be converged at the position closer to the object 11, thereby facilitating application of ultrasonic vibrations of high intensity to contaminants stuck on the object 11.

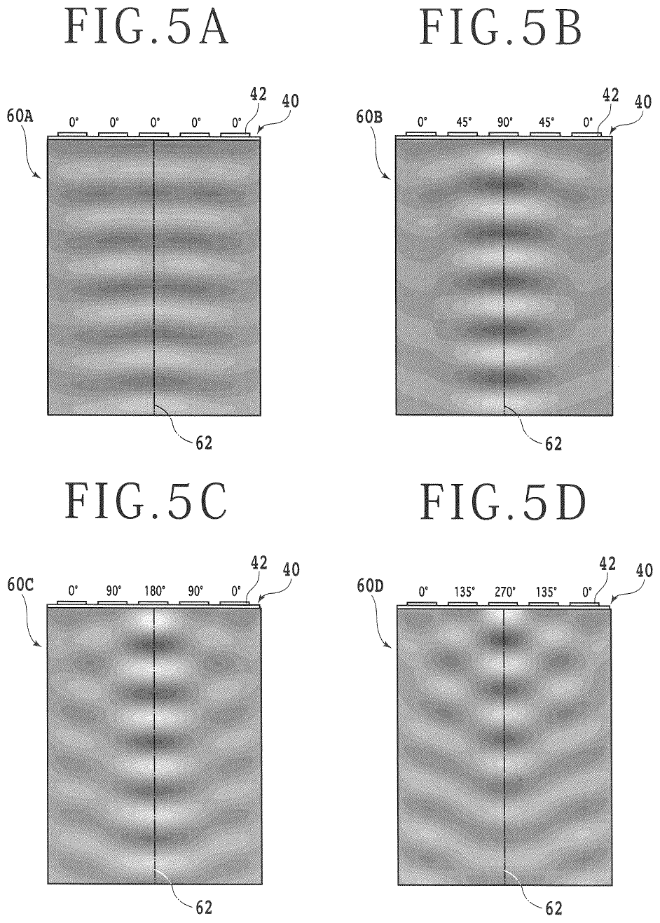

With reference to FIGS. 5A to 5D, a description will next be made of examples of propagation control of ultrasonic waves by phased array control. Here, the description will be made of the sound pressure of ultrasonic waves propagating in liquid when phased array control is conducted with the five transducers 42 arranged on the vibration plate 40.

FIGS. 5A to 5D present by way of examples contour FIGS. 60A to 60D of the sound pressure [MPa] of the ultrasonic waves propagating in the liquid when four different kinds of phased array control were conducted. In each of the contour FIGS. 60A to 60D, the maximum value (positive value) of the sound pressure of the ultrasonic waves is presented in white, while the minimum value (negative value) of the sound pressure of the ultrasonic waves is presented in black. In each of FIGS. 5A to 5D, the numerical value affixed to each transducer 42 presents a phase shift (phase delay) of the corresponding ultrasonic waves from 0° as a reference. Further, a reference line 62 is a hypothetical straight line that is perpendicular to the vibration plate 40 and that passes through the center of the vibration plate 40, and corresponds to the reference line 50 (see FIG. 4). The contour FIGS. 60B to 60D (FIGS. 5B to 5D) present the sound pressures of ultrasonic waves when phased array control was so conducted that the ultrasonic vibrations would be more delayed as the transducers 42 are located closer to the reference line 62.

FIG. 5A is the contour FIG. 60A presenting the sound pressure of ultrasonic waves created by phased array control with a phase shift set at 0°. If there is no phase shift among the ultrasonic vibrations emitted by the transducers 42, the ultrasonic wave (resultant wave) propagates along the reference line 62 in the liquid, but does not converge on the reference line 62. The sound pressure of the ultrasonic wave is thus unlikely to increase or decrease on the reference line 62, so that the intensity of the ultrasonic wave propagating in the liquid is low.

FIG. 5B is the contour FIG. 60B presenting the sound pressure of ultrasonic waves created by phased array control with a phase shift set at 45°. Further, FIG. 5C is the contour FIG. 60C presenting the sound pressure of ultrasonic waves created by phased array control with a phase shift set at 90°. If the phase shift of ultrasonic vibrations to be emitted by the transducers 42 is set at 45° or 90°, the ultrasonic wave (resultant wave) converges on or in a vicinity of the reference line 62. As a result, the sound pressure significantly increases or decreases on or in the vicinity of the reference line 62 to take a maximum value or a minimum value, so that the ultrasonic wave propagates in the liquid while retaining high intensity.

FIG. 5D is the contour FIG. 60D presenting the sound pressure of ultrasonic waves created by phased array control with a phase shift set at 135°. The ultrasonic wave (resultant wave) also converges on or in a vicinity of the reference line 62 if the phase shift of ultrasonic vibrations to be emitted by the transducers 42 is set at 135°. Compared with the case in which the phase shift is 45° or 90°, however, the ultrasonic wave converges at a position closer to the vibration plate 40, so that the intensity of the ultrasonic wave becomes weak at positions remote from the vibration plate 40.

By the propagating direction, the converging position, and the like of the ultrasonic waves 54 in the liquid 24 being controlled through phased array control as described above (see FIG. 4), the ultrasonic waves 54 are facilitated to reach the object 11 via the supply port 26b, so that ultrasonic vibrations can efficiently be applied to the object 11. It is to be noted that the case in which the ultrasonic waves 54 propagate along the reference line 50 and converge at the converging position 56 on the reference line 50 has been described with reference to FIG. 4, but the propagation control of the ultrasonic waves 54 is not limited to such propagation control. For example, the propagating direction of the ultrasonic waves 54 may be inclined with respect to the reference line 50. Further, the converging position 56 of the ultrasonic waves 54 can also appropriately be set according to the distance between the object 11 and the rinsing nozzle 22.

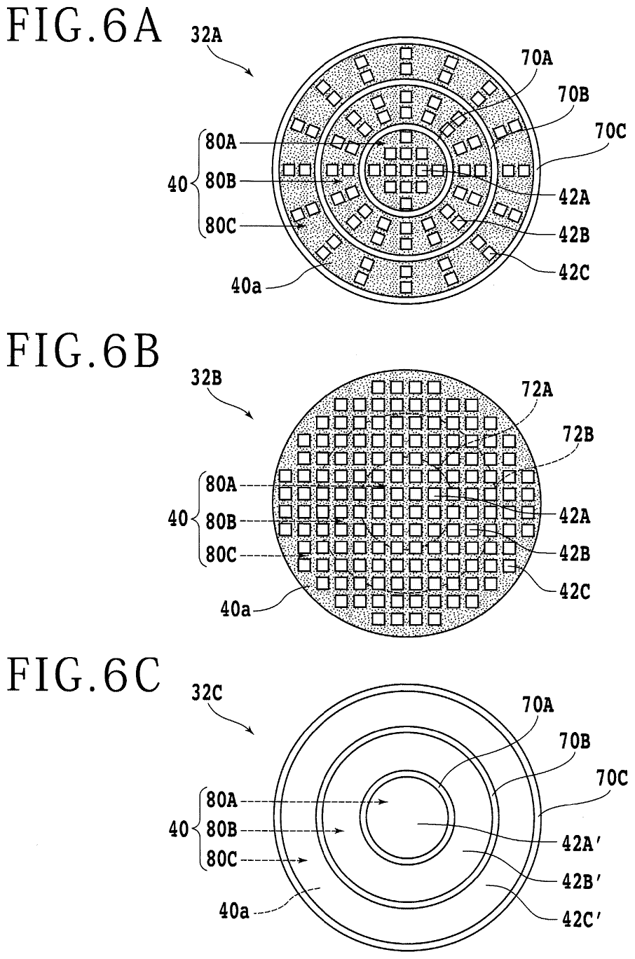

A description will next be made of specific examples of the array of the transducers 42. Vibration applying units 32A, 32B, and 32C depicted in FIGS. 6A to 6C correspond to specific examples of the vibration applying unit 32, respectively, and each include a disk-shaped vibration plate 40. It is to be noted that, in each of FIGS. 6A and 6B, a pattern is applied to a first surface 40a of the vibration plate 40 to clarify distinction between the vibration plate 40 and other elements.

FIG. 6A is a plan view depicting the vibration applying unit 32A. The vibration applying unit 32A includes annular dividers 70A, 70B, and 70C disposed on a side of the first surface 40a of the vibration plate 40. The annular dividers 70A, 70B, and 70C are annular members made from the same or different material as the vibration plate 40, and are so disposed as to upwardly protrude from the first surface 40a of the vibration plate 40. The divider 70B has an inner diameter greater than an outer diameter of the divider 70A, and the divider 70C has an inner diameter greater than an outer diameter of the divider 70B. Further, the dividers 70A, 70B, and 70C are concentrically arranged such that their centers overlap with a center of the vibration plate 40. In addition, the divider 70C is arranged along an outer peripheral edge of the vibration plate 40.

The vibration plate 40 is divided into regions 80A, 80B, and 80C by the dividers 70A, 70B, and 70C. The region 80A corresponds to a circular region inside the divider 70A, and includes the center of the vibration plate 40. The region 80B corresponds to an annular region between the divider 70A and the divider 70B. The region 80C corresponds to an annular region between the divider 70B and the divider 70C. Hence, the regions 80A, 80B, and 80C correspond to a plurality of regions of a similar kind and of different distances from the center of the vibration plate 40, and in the regions 80A, 80B, and 80C, the first surface 40a of the vibration plate 40 is exposed.

The vibration applying unit 32A also includes a plurality of transducers 42A, a plurality of transducers 42B, and a plurality of transducers 42C. The transducers 42A, 42B, and 42C are all connected to the side of the first surface 40a of the vibration plate 40. It is to be noted that the transducers 42A, 42B, and 42C are similar in configuration, function, and the like to the above-mentioned transducers 42 (see FIG. 3, etc.). The transducers 42A are arranged in the region 80A, the transducers 42B are arranged in the region 80B, and the transducers 42C are arranged in the region 80C. The transducers 42A, 42B, and 42C are hence arrayed such that their distances from the center of the vibration plate 40 differ from one another in each common radial direction.

It is to be noted that no limitations are imposed on the number and array of the transducers 42A, 42B, or 42C in each of the regions 80A, 80B, and 80C. For example, as depicted in FIG. 6A, a first group of transducers 42A of an equal distance from the center of the vibration plate 40 and a second group of transducers 42A of a distance that is equal to one another from the center of the vibration plate 40 but is different from that of the first group of transducers 42A may be mixed in the region 80A. Further, a first group of transducers 42B of an equal distance from the center of the vibration plate 40 and a second group of transducers 42B of a distance that is equal to one another from the center of the vibration plate 40 but is different from that of the first group of transducers 42B may be mixed in the region 80B. Further, a first group of transducers 42C of an equal distance from the center of the vibration plate 40 and a second group of transducers 42C of a distance that is equal to one another from the center of the vibration plate 40 but is different from that of the first group of transducers 42C may be mixed in the region 80C.

The transducers 42A, 42B, and 42C are connected to the ultrasonic generator 34 (see FIG. 2, etc.). When radiofrequency power is supplied from the ultrasonic generator 34 to the transducers 42A, 42B, and 42C, the transducers 42A, 42B, and 42C apply ultrasonic vibrations to the regions 80A, 80B, and 80C of the vibration plate 40, respectively. When phased array control of the transducers 42A, 42B, and 42C is conducted, radiofrequency power to be supplied from the ultrasonic generator 34 to the transducers 42A, 42B, and 42C is so controlled that phase shifts occur in ultrasonic vibrations to be emitted by the transducers 42A, 42B, and 42C. In addition, a phase shift may be caused to occur in ultrasonic vibrations between the first group and the second group of transducers 42A, between the first group and the second group of transducers 42B, and/or between the first group and the second group of transducers 42C.

FIG. 6B is a plan view depicting the vibration applying unit 32B. Different from the vibration applying unit 32A (see FIG. 6A), no annular divider is disposed on the vibration plate 40 of the vibration applying unit 32B. Yet, the vibration plate 40 of the vibration applying unit 32B is divided into regions 80A, 80B, and 80C by annular boundaries 72A and 72B. The boundaries 72A and 72B are equivalent to hypothetical dividing lines that divide the vibration plate 40. The boundary 72A has a diameter smaller than that of the boundary 72B, and the boundaries 72A and 72B are concentrically arranged such that their centers overlap with a center of the vibration plate 40. The region 80A corresponds to a circular region inside the boundary 72A, and includes the center of the vibration plate 40. The region 80B corresponds to an annular region between the boundary 72A and the boundary 72B. The region 80C corresponds to an annular region outside the boundary 72B, and includes an outer peripheral edge of the vibration plate 40.

The vibration applying unit 32B also includes a plurality of transducers 42A, a plurality of transducers 42B, and a plurality of transducers 42C. The transducers 42A, 42B, and 42C are arranged in a grid pattern, and are connected to a side of a first surface 40a of the vibration plate 40. Described specifically, the transducers 42A, 42B, and 42C are arrayed at predetermined intervals along two directions that are perpendicular to each other (in the up-to-down direction and the left-to-right direction in FIG. 6B). It is to be noted that FIG. 6B depicts an example in which the transducers 42A, 42B, and 42C are arrayed in 14 rows×14 columns, but no limitations are imposed on the number of rows and the number of columns of the transducers 42A, 42B, and 42C.

The transducers 42A are arranged in the region 80A, the transducers 42B are arranged in the region 80B, and the transducers 42C are arranged in the region 80C. The transducers 42A, 42B, and 42C are hence arrayed such that their distances from the center of the vibration plate 40 differ from one another in each common radial direction. It is to be noted that in FIG. 6B, the transducers arranged on the boundary 72A may be considered to be the transducers 42A or may be considered to be the transducers 42B. It is also to be noted that the transducers arranged on the boundary 72B may be considered to be the transducers 42B or may be considered to be the transducers 42C.

The transducers 42A, 42B, and 42C are all connected to the ultrasonic generator 34 (see FIG. 2, etc.). When radiofrequency power is supplied from the ultrasonic generator 34 to the transducers 42A, 42B, and 42C, the transducers 42A, 42B, and 42C apply ultrasonic vibrations to the regions 80A, 80B, and 80C, respectively. When phased array control of the transducers 42A, 42B, and 42C is conducted, the radiofrequency power to be supplied from the ultrasonic generator 34 to the transducers 42A, 42B, and 42C is so controlled that phase shifts occur in ultrasonic vibrations to be emitted by the transducers 42A, 42B, and 42C. In addition, a phase shift may be caused to occur in ultrasonic vibrations between the transducers 42A of different distances from the center of the vibration plate 40, between the transducers 42B of different distances from the center of the vibration plate 40, and/or between the transducers 42C of different distances from the center of the vibration plate 40.

FIG. 6C is a plan view depicting the vibration applying unit 32C. Similar to the vibration applying unit 32A (see FIG. 6A), the vibration applying unit 32C includes annular dividers 70A, 70B, and 70C disposed on a side of a first surface 40a of a vibration plate 40. The vibration plate 40 of the vibration applying unit 32C is divided into regions 80A, 80B, and 80C by the dividers 70A, 70B, and 70C.

Further, the vibration applying unit 32C includes a transducer 42A′, a transducer 42B′, and a transducer 42C′. The transducers 42A′, 42B′, and 42C′ are similar in configuration, function, and the like to the above-mentioned transducers 42 (see FIG. 3, etc.). However, the transducers 42A′, 42B′, and 42C′ are different in shape from the transducers 42A, 42B, and 42C depicted in FIGS. 6A and 6B. Described specifically, the transducer 42A′ is formed in a circular shape corresponding to the region 80A, and is connected to the region 80A. Further, the transducer 42B′ is formed in an annular shape corresponding to the region 80B, and is connected to the region 80B. Furthermore, the transducer 42C′ is formed in an annular shape corresponding to the region 80C, and is connected to the region 80C. Hence, the transducer 42A′ is arranged inside the divider 70A, the transducer 42B′ is arranged between the divider 70A and the divider 70B, and the transducer 42C′ is arranged between the divider 70B and the divider 70C.

When the transducers 42A′, 42B′, and 42C′ are connected to the vibration plate 40 as described above, the transducers 42A′, 42B′, and 42C′ are concentrically arranged such that their centers overlap with a center of the vibration plate 40. The transducers 42A′, 42B′, and 42C′ are also arranged such that their distances from the center of the vibration plate 40 differ.

It is to be noted that, in the vibration applying unit 32C, the first surface 40a of the vibration plate 40 is covered by the transducers 42A′, 42B′, and 42C′ and the dividers 70A, 70B, and 70C. The first surface 40a of the vibration plate 40 is thus not exposed. However, clearances may exist between the transducers 42A′, 42B′, and 42C′ and the dividers 70A, 70B, and 70C. Further, the dividers 70A, 70B, and 70C can be omitted from the vibration applying unit 32C.

The transducers 42A′, 42B′, and 42C′ are connected to the ultrasonic generator 34 (see FIG. 2, etc.). When radiofrequency power is supplied from the ultrasonic generator 34 to the transducers 42A′, 42B′, and 42C′, the transducers 42A′, 42B′, and 42C′ apply ultrasonic vibrations to the regions 80A, 80B, and 80C of the vibration plate 40, respectively. When phased array control of the transducers 42A′, 42B′, and 42C′ is conducted, the radiofrequency power to be supplied from the ultrasonic generator 34 to the transducers 42A′, 42B′, and 42C′ is controlled such that phase shifts occur in ultrasonic vibrations to be emitted by the transducers 42A′, 42B′, and 42C′.

By transducers being connected to a plurality of regions of different distances from the center of the vibration plate 40, respectively, as described above, the vibration applying unit 32 is configured to permit phase array control. It is to be noted that the examples in which the vibration plate 40 is divided into three regions (the regions 80A, 80B, and 80C) have been described with reference to FIGS. 6A to 6C, but the vibration plate 40 may be divided into four or more regions of different distances from the center of the vibration plate 40. If this is the case, the transducers are connected to the individual regions, respectively.

As described above, the rinsing nozzle 22 according to this embodiment is configured to permit controlling the propagation of ultrasonic waves which are to be applied from the flat vibration plate 40 to the liquid 24, through phased array control of the transducers 42. Owing to this configuration, ultrasonic waves are allowed to efficiently propagate to the object 11 via the liquid 24.

In the above-described embodiment, the description is made of the case in which the vibration applying unit 32 includes the disk-shaped vibration plate 40. The vibration plate 40 may however be constructed by a plurality of independent vibration plates. For example, the vibration plate 40 may include a disk-shaped first vibration plate corresponding to the region 80A, an annular second vibration plate corresponding to the region 80B, and an annular third vibration plate corresponding to the region 80C. If this is the case, the first vibration plate, the second vibration plate, and the third vibration plate can be arranged apart from one another.

Moreover, structure, methods, and the like according to the above-described embodiment can be practiced with changes or modifications made as appropriate insofar as not departing from the object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A rinsing nozzle for rinsing an object by supplying liquid to the object while propagating ultrasonic waves to the liquid, comprising:
a case having an internal space that holds the liquid therein, a supply port that supplies the liquid from the internal space toward the object, and a connecting portion that connects a liquid supply source, which supplies the liquid, and the internal space;
a flat vibration plate disposed in the internal space in such a manner as to face the supply port; and
a plurality of transducers that apply ultrasonic waves to the vibration plate,
wherein propagation of ultrasonic waves to be applied from the vibration plate to the liquid can be controlled by phased array control of the transducers.

2. The rinsing nozzle according to claim 1, wherein the rinsing nozzle is configured to allow the ultrasonic waves applied from the vibration plate to the liquid to converge on a straight line that is perpendicular to the supply port and that passes through a center of the supply port.

3. The rinsing nozzle according to claim 1, wherein the transducers are arrayed in a grid pattern.

4. The rinsing nozzle according to claim 1, wherein the transducers are formed in a circular or annular shape and are arranged concentrically.
